(19) United States
(12) Patent Application Publication
(10) Pub. No.: US 2008/0196191 A1
(43) Pub. Date: Aug. 21, 2008

(54) Wiper Device for a Motor Vehicle Windscreen Provided with a Linearly Movable Windscreen Wiper

(75) Inventors: Gerard Jeuffe, Bazemont (FR); Olivier Kugener, Brion Pres Thouet (FR); Yannick Hervot, Montreuil Bellay (FR); Yannick Doucet, Bagneux (FR); Olivier Dequirot, Saint Martin De Sanzay (FR)

Correspondence Address: NICOLAS E. SECKEL;Patent Attorney, 1250 Connecticut Avenue, NW Suite 700, WASHINGTON, DC, 20036, US

(73) Assignees: PEUGEOT CITROEN AUTOMOBILES SA, Velizy Villacoublay (FR); EURAMAX INDUSTRIES SA, Montreuil Bellay (FR)

(21) Appl. No.: 11/995,041

(22) PCT Filed: Jun. 28, 2006
(86) PCT No.: PCT/FR06/01501

§ 371 Date: Feb. 14, 2008

(30) Foreign Application Priority Data
Jul. 8, 2005 (FR) 0507349

(51) Int. Cl. B60S 1/04

(52) U.S. Cl. 15/250.29

(57) ABSTRACT

This window wiping device (2) comprises a linearly displaceable window wiper arm (11) which is carried by a carriage (12) which is guided by a guide rail (13) which is connected to a transmission means (15) which is moved by a drive means (14), and is characterised in that the guide rail (13) comprises at least one longitudinal channel for retaining an element of the transmission means (15) and in that the transmission means is flexible and comprises an element which can slide in the longitudinal channel of the guide rail (13).

The present invention relates to a device for wiping a window comprising a linearly displaceable window wiper arm. Such a device can be used particularly for wiping the windows of a car and in particular the rear window.

There are known devices for wiping windows for motor vehicles comprising a linearly displaceable window wiper arm which is carried by a carriage which is guided by a guide rail and which is driven by a transmission means connected to a drive means.

There are known in particular devices in which the carriage which carries the window wiper arm is moved by an endless screw which is obviously straight, which requires specific devices in order to allow the window wiper arm to remain permanently in a state correctly pressed against the window, in particular when the window has a given shape.

Those devices having endless screws may involve an endless screw having a single thread and an endless screw having a double thread. The advantage of the endless screws having a double thread is that those screws can be moved by a motor which rotates in a single direction, the reversal of the movement of the window wiper when it reaches the end of the screw is brought about by a device which allows the movement of a thread in one direction to be switched to a thread in the opposite direction.

Such devices have the disadvantage of being complex and taking up a relatively large amount of space.

There are also known devices in which the carriage which carries the window wiper arm is moved by an endless cable which is supported by two pulleys which are located at each of the ends of a guide rail, the pulleys being driven by a motor. Such a device has the disadvantage of requiring means for tensioning the cable so as to permanently ensure the high quality of the movement of the cable by the pulleys on which it is supported.

Such devices are also complex and take up a large amount of space, in particular when they have to be adapted to a Window which has a given shape.

The object of the present invention is to overcome those disadvantages by providing a window wiping device comprising a linearly displaceable window wiper arm which can be readily manipulated with a device which takes up little space and which can be adapted to Windows of any shape.

To that end, the invention relates to a window wiping device comprising a linearly displaceable window wiper arm which is carried by a carriage which is guided by a guide rail which is connected to a transmission means which is moved by a drive means. The guide rail comprises at least one longitudinal channel for retaining an element of the transmission means and the transmission means is flexible and comprises an element which can slide in the longitudinal channel of the guide rail.

The transmission means is preferably a flexible rack which can be constituted by a flexible cable comprising a core, around which a wire is wound in a helical manner, the flexible cable sliding in a sheath, one end of which is fixedly joined to one end of the longitudinal channel of the guide rail, the other end being fixedly joined to an output of the drive means, the flexible cable being connected at one of the ends thereof to the carriage.

The drive means may comprise a toothed wheel which is driven by an electric motor, the toothed wheel co-operating with the wire which is helically wound around the core of the flexible cable.

The device may also comprise means for controlling the movement of the carriage which carries the window wiper arm.

Preferably, the guide rail further comprises at least one longitudinal guide groove and the carriage which carries the window wiper arm comprises at least a first runner which is fixedly joined to one end of the element of the transmission means and which slides in the channel of the guide rail, and at least a second runner which slides in a longitudinal guide groove of the guide rail.

Preferably, the second runner comprises at least one play compensation means which is constituted by at least one resilient plate which is intended to co-operate with a lateral face of the guide groove.

The device can be mounted on a motor vehicle in order to wipe the glass pane of a rear window, the guide rail preferably being arranged above the rear window and having a shape which conforms to the shape of the rear window.

The drive means is, for example, arranged below the rear window, under the external wall of the body portion which comprises the rear window.

The invention also relates to a motor vehicle which comprises at least one window wiping device.

The invention will now be described in greater detail, but in non-limiting manner, with reference to the appended Figures, in which:

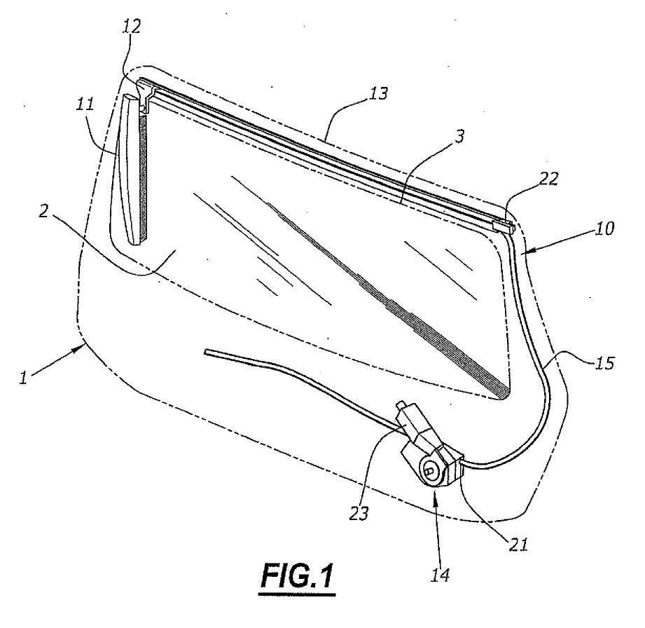

FIG. 1 is a perspective view of a wiping device of a car window,

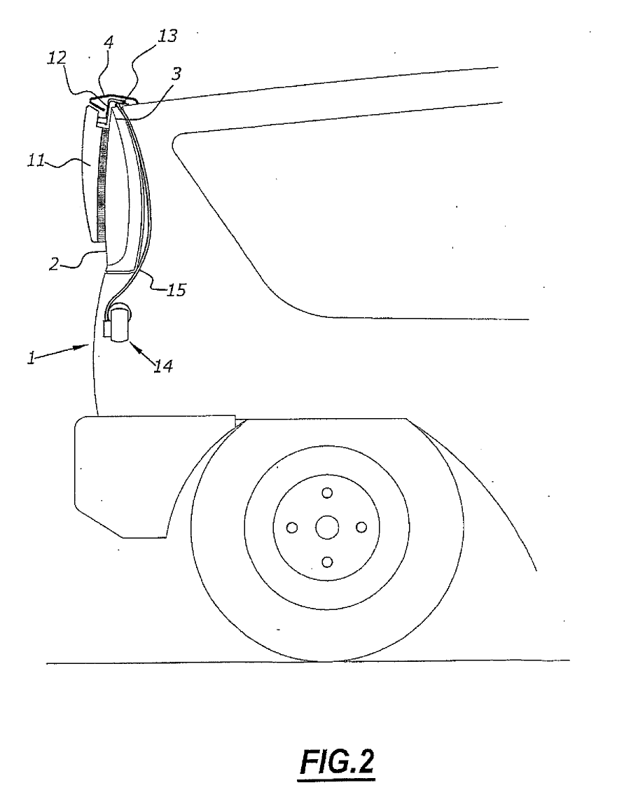

FIG. 2 is a profile view of the rear of a car which is provided with a device for wiping the glass pane of the rear window,

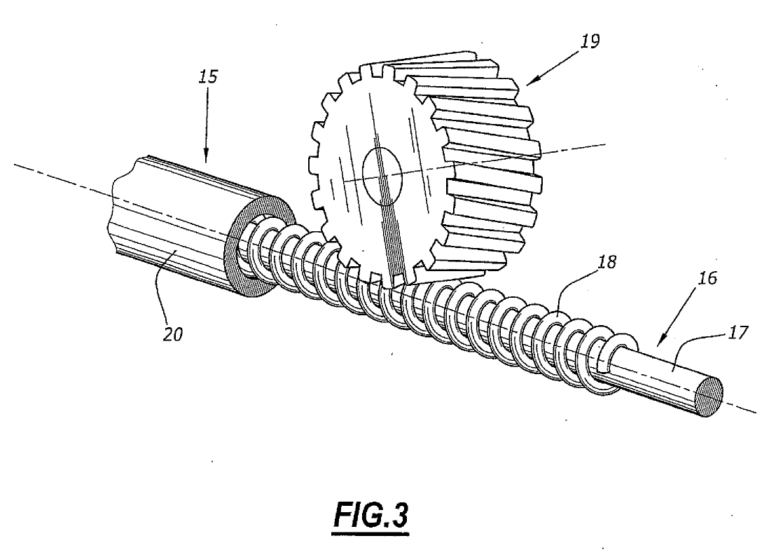

FIG. 3 is a schematic perspective view of a flexible rack,

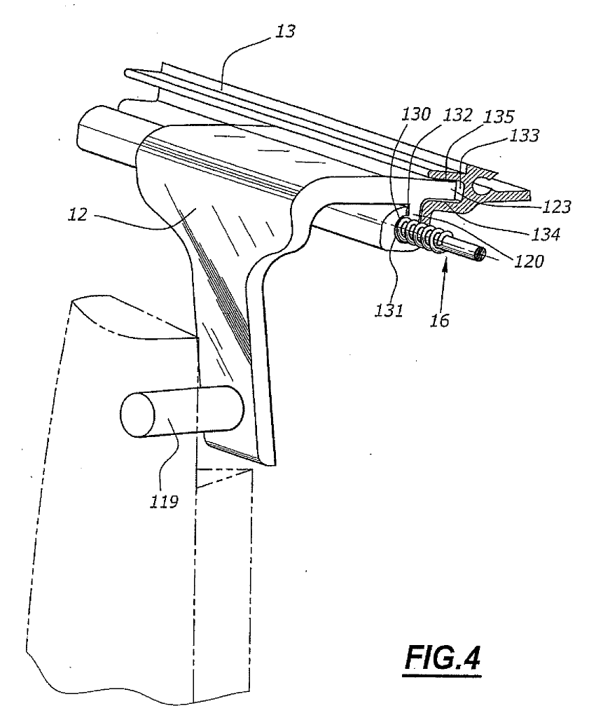

FIG. 4 is a perspective view of a carriage for supporting a window wiper arm which is mounted in a guide rail,

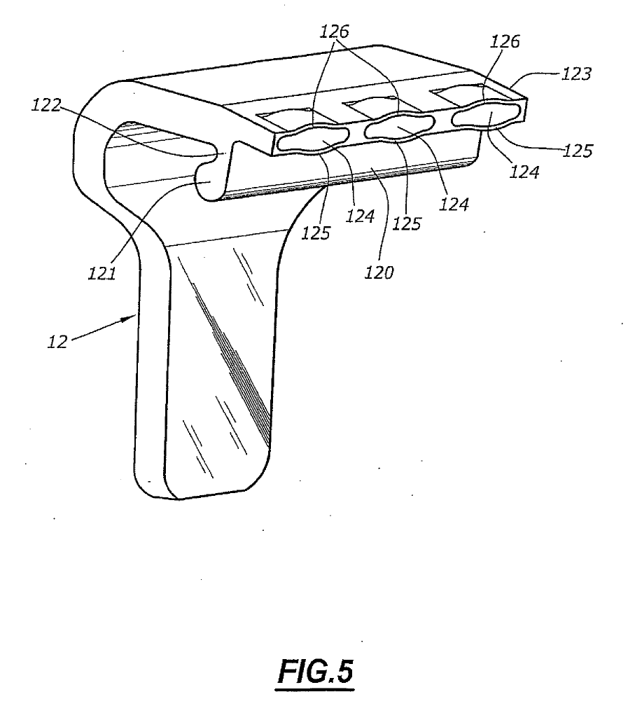

FIG. 5 is a perspective view of a carriage for supporting the linearly displaceable window wiper arm.

The rear portion of a motor vehicle illustrated in FIG. 1 is, for example, a rear door which is generally designated 1 and whose outer surface has been removed and which comprises a rear window 2. There is arranged in that rear door a device for wiping the window which is generally designated 10 and which comprises a linearly displaceable window wiper arm 11 which is known per se and which is carried by a carriage 12 which slides in a guide rail 13 which extends along the upper edge 3 of the rear window 2. The carriage 12 is moved by a drive means which is generally designated 14 and which moves a transmission means 15 which is connected to the carriage 12. It will be appreciated that the transmission means 15 extends in particular between an output 21 of the drive means 14 and an end 22 of the guide rail 13. As will be appreciated below, the transmission means 15 comprises an element which slides inside a guide channel which is provided in the guide rail 13.

As is visible in FIG. 3, the transmission means generally designated 15 is a flexible rack which is constituted by a cable which is generally designated 16 and which comprises a central core 17, around which a metal wire 18, or more generally a strand which will be generally referred to as a wire, is wound in a helical manner.

The cable generally designated 16 slides inside a sheath 20. The sheath 20 is rigidly connected, at one side, to an output 21 of the drive means and, at the other side, to an input end 22 in a channel of the guide rail 13. Inside the drive means 14, the cable 16 co-operates with a toothed wheel 19 by means of the helical winding 18. The toothed wheel 19 which is driven by a geared motor 23 allows the cable 16 to be moved longitudinally. The cable 16, one end of which is fixed to the carriage 12, is held in a sheath, the two ends of which are connected to fixed locations in order to be able to bring about movement by applying an effort in one direction or the other in order to move the carriage 12. It will be appreciated that such a flexible rack is known per se to the person skilled in the art.

The carriage 12 which carries the window wiper arm by way of a fixing means 119 of the window wiper arm comprises a first runner 120 which slides in a longitudinal channel 130 of the guide rail which comprises a cylindrical portion 131 in which the cable 16 of the drive means which is fixed to the carriage 12 can slide so as to move the carriage in a translation movement in one direction or the other.

The channel 130 also comprises a longitudinal slot 132 which extends over the entire length of the guide rail and which allows the runner 120 of the supporting carriage 12 to pass.

The carriage 12 for supporting the window wiper arm also comprises a second runner 123 which slides in a guide groove 133 which extends over the entire length of the guide rail 13.

The channel 130, as has been seen, serves to retain the transmission cable 16 in such a manner that it can function in terms of both traction and compression.

The guide groove 133 serves to fix in position the window wiper arm carrying carriage 12 so as to prevent it from pivoting.

Preferably, the channel 130 and the groove 133 are orientated at right-angles relative to each other which allows, owing to the reactions of their edges on the two runners, the carriage 12 to be completely guided, allowing only one degree of freedom corresponding to translation along the rail.

As is visible in FIG. 5, which is an enlarged perspective view of a carriage 12, the runner 120 comprises a cylindrical head 121 which is connected to the body of the runner by a narrower rib 122. The cylindrical head 121 which slides in the cylindrical portion of the guide channel brings about, on the one hand, the connection with respect to the cable 16 of the transmission means and, on the other hand, longitudinal guiding of the carriage 12. The movement of the carriage is controlled by that head 121 sliding inside the cylindrical portion 131 of the guide channel 130. The rib 122 which is a rib for connection with respect to the body of the carriage 12 slides through the slot 132 which simply brings about the passage of the rib 122.

The second runner 123 which slides in the guide groove 133 co-operates with the lateral faces 134 and 135 of the channel and thereby prevents the carriage 12 from pivoting. In order to remain permanently in a state correctly retained in the longitudinal guide groove 133, the runner 123 comprises play compensation elements 124 which are constituted by two resilient tongues 125 and 126 which protrude towards the outer side of the lateral walls of the runner. Those resilient elements 125 and 126 come into contact with the lateral faces 134 and 135 of the guide groove 133.

Naturally, the device also comprises control means which are not illustrated and which a person skilled in the art knows and knows how to construct. In particular, means for detecting the presence of the carriage at the ends of the rail so as to control the reversals of the movement direction.

The device comprises means for retaining the window wiper arm on the carriage for carrying the window wiper arm and the means which allow the window wiper arm to be pressed against the window to be wiped and which are not described because they are known per se to the person skilled in the art.

The device which has been described above and which substantially consists in using a flexible rack in order to move a carriage which slides in a guide rail and which carries a window wiper arm can be used in order to wipe any motor vehicle window.

When the device is used in order to wipe the glass pane of the rear window of the motor vehicle, the guide rail of the carriage of the window wiper arm which moves laterally along the upper edge 3 of the rear window 2 can be concealed under a spoiler 4 which extends laterally over the rear portion of the vehicle.

Finally, since the means for moving the window wiper arm is constituted by a flexible rack which slides in a rail which may have a certain curvature, the device is well suited to wiping shaped windows.

1. Device for wiping a window comprising a linearly displaceable window wiper arm which is carried by a carriage which is guided by a guide rail which is connected to a transmission means which is moved by a drive means wherein the guide rail comprises at least one longitudinal channel for retaining an element of the transmission means and the transmission means is flexible and comprises an element which can slide in the longitudinal channel of the guide rail.

2. Device according to claim 1, wherein the transmission means is a flexible rack.

3. Device according to claim 2, wherein the flexible rack is constituted by a flexible cable comprising a core, around which a wire (1 8) is wound in a helical manner, the flexible cable sliding in a sheath, one end of which is fixedly joined to one end of the channel which extends along the guide rail, the other end being fixedly joined to an output of the drive means, the flexible cable being connected at one of the ends thereof to the carriage.

4. Device according to claim 3, wherein the drive means comprises a toothed wheel which is driven by an electric motor, the toothed wheel co-operating with the wire which is helically wound around the core of the flexible cable.

5. Device according to claim 4, which further comprises means for controlling the movement of the carriage which carries the window wiper arm.

6. Device according to claim 1, wherein the guide rail further comprises least one longitudinal guide groove and the carriage which carries the window wiper arm comprises at least a first runner which is fixedly joined to one end of the element of the transmission means and which slides in the channel of the guide rail, and at least a second runner which slides in a longitudinal guide groove of the guide rail.

7. Device according to claim 6, wherein the second runner comprises at least one play compensation means which is constituted by at least one resilient plate which is intended to co-operate with a lateral face the guide groove.

8. Device according to claim 1, which is mounted on a motor vehicle in order to wipe the glass pane of a rear Window.

9. Device according to claim 8, wherein the guide rail is arranged above the rear window Hand has a shape which conforms to the shape of the rear window.

10. : Device according to claim 9, wherein the drive means is arranged below the rear window, under the external wall of the body portion which comprises the rear window.

11. Motor vehicle, which comprises at least one window wiping device according to claim 1.
